(19) United States
(12) Patent Application Publication
(10) Pub. No.: US 2012/0108741 A1
(43) Pub. Date: May 3, 2012

(54) AMBIENT-TEMPERATURE SELF-CURABLE AND FLUORINE CONTAINING AQUEOUS-BASED POLYURETHANE (PU) DISPERSION AND METHOD OF MANUFACTURING THE SAME AND ITS MODIFIED COATED FILM APPLICATIONS

(75) Inventors: Rei-Xin Wu, Douliu City (TW); Jing-Zhong Hwang, Tainan City (TW); Wei-Hung Chen, Taipei City (TW); Kan-Nan Chen, Taipei City (TW)

(73) Assignee: Tai-Chang Chou, Taipei City (TW)

(21) Appl. No.: 13/281,729

(22) Filed: Oct. 26, 2011

(30) Foreign Application Priority Data
Oct. 28, 2010 (TW) 99137027

(51) Int. Cl. C09D 175/04

(52) U.S. Cl. 524/591

(57) ABSTRACT

An ambient-temperature self-curable fluorine containing aqueous-based polyurethane dispersion, a method of manufacturing the same and its modified coated film applications are provided. The ambient-temperature self-curable fluorine containing aqueous-based PU dispersion includes water, an ambient temperature cross-linking agent and a fluorine containing PU resin dispersed in water phase. The fluorine containing PU resin includes

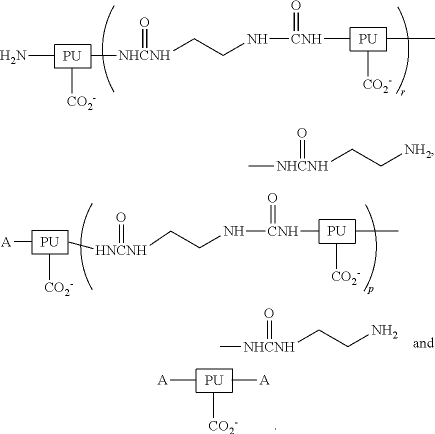

A includes octa-fluoropentanol, hexafluoroisopropanol, trifluoroethanol, tetrafluoropropanol or trifluoroethylamine.

Treated fabric with the self-cured fluorine containing aqueous-based PU resin and it becomes a long-lasting water-repellent and stain-proof.

This application claims the benefit of Taiwan application Serial No. 0 99137027, filed Oct. 28, 2010, the subject matter of which is incorporated herein by reference.

### BACKGROUND OF THE INVENTION

1. Field of the Invention

The invention relates in general to ambient-temperature self-curable fluorine containing aqueous-based polyurethane dispersion and method of manufacturing the same, and more particularly to ambient-temperature self-curable fluorine containing aqueous-based polyurethane dispersion and method of manufacturing the same used for forming a modified coated film which is water repellent and stain resistant.

2. Description of the Related Art

Along with the development and advance in textile technology which provides high-performance and long lasting properties in order to meet the requirements of comfortable and healthy textiles. These excellent functional properties such as, softness, breathability, water-repellence and stain-resistance. Furthermore, an environment friendly process also becomes essential for these functional textile treatments.

However, some existing functional textiles have following disadvantages:

1) Poor hand-feel: the treated textile with water repellent agent of will form a continuous film coating on its surface, that not only giving poor hand-feel but also becoming non-breathable.

2) Poor washing durability: the textile water repellence agent normally is a polymeric film (e.g. PTFE) or a resin without any functional groups for further cross-linking reaction or binding with textile surface. There is only physical attractions without chemical bonds among water repellence agent and textile surface after treatment. Therefore, it will be washed away or peeled off after several washing cycles.

3) High cost: an excellent water-repellent textile is obtained from a complicated treatment process with micro-porous polytetrafluoroethene (PTFE) film with adhesives, which incurs high material cost. Thus the technology threshold and processing cost are both increased;

4) Inconvenient operation in processing: some treated textiles with a high-temperature or a complicated lamination operation process is required.

### SUMMARY OF THE INVENTION

The invention is directed to an ambient-temperature self-curable fluorine containing aqueous-based polyurethane (PU) dispersion, a method of manufacturing the same and a modified coated film. The ambient-temperature self-curable fluorine containing aqueous-based PU dispersion is used to form a modified coated film providing excellent hand-feel, long lasting water resistance, solvent resistance, and possessing excellent adhesion and penetration with respect to various bases such as fabrics (such as cotton cloth, nylon, polyester (PET) and so on). The PU dispersion of the invention incurs low cost and is an environmental friendly green process.

According to an object the present invention, an ambient-temperature self-curable fluorine containing aqueous-based PU dispersion is provided. The ambient-temperature self-curable fluorine containing aqueous-based PU dispersion includes water, an ambient temperature cro a cross-linking agent and a fluorine containing PU resin dispersed in water phase. The fluorine containing PU resin includes:

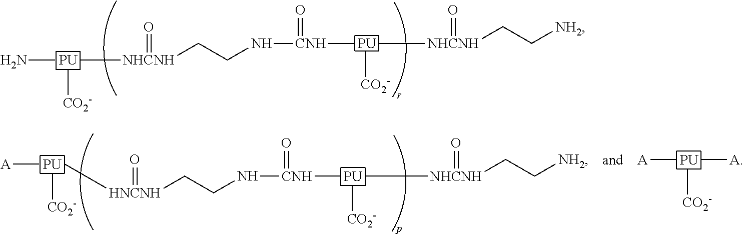

A includes octa-fluoropentanol, hexafluoroisopropanol, trifluoroethanol, tetrafluoropropanol or trifluoroethylamine.

According to an object of the invention, a method of manufacturing an ambient-temperature self-curable fluorine containing aqueous-based PU dispersion is provided. The method includes the following steps. A first mixture is provided, wherein the first mixture includes a melted mixture, poly isocyanate and a first catalyst. The molten mixture is formed by melting the polyol and the dimethylol propionic acid (DMPA). The first catalyst may include dibutyl tin octoate (T-12). The first mixture is heated to synthesize a PU prepolymer. A fluorine containing compound, a second catalyst and the PU prepolymer are mixed to obtain a second mixture. The second catalyst includes T-12. The second mixture is heated to synthesize a fluorine containing PU hybrid oligomer. A triethylamine (TEA) is added to neutralize the fluorine containing PU hybrid oligomer, and its pH is adjusted to be over 8.0. The neutralized fluorine containing PU hybrid oligomer is added to mix with a solution containing a chain extender to form a PU resin dispersion. The chain extender includes ethylenediamine (EDA). Water is added to adjust the solid content of the PU resin dispersion as 0.1 wt. %˜45 wt. % to form a fluorine containing aqueous-based PU dispersion. The fluorine containing aqueous-based PU dispersion and an ambient-temperature cross-linking agent are mixed to form an ambient-temperature self-curable fluorine containing aqueous-based PU dispersion. The weight of the ambient-temperature cross-linking agent amounts to 1%˜10 wt. % of the solid content of the fluorine containing aqueous-based PU dispersion.

According to an alternative object of the invention, a modified coated film is provided. The modified coated film is manufactured from an ambient-temperature self-curable fluorine containing aqueous-based PU dispersion which is dried and coated on a base.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

None

### DETAILED DESCRIPTION OF THE INVENTION

Ambient-temperature self-curable fluorine containing aqueous-based PU dispersion

The ambient-temperature self-curable fluorine containing aqueous-based PU dispersion of an embodiment of the invention includes water, an ambient temperature cross-linking agent and a fluorine containing PU resin. The fluorine containing PU resin may comprise

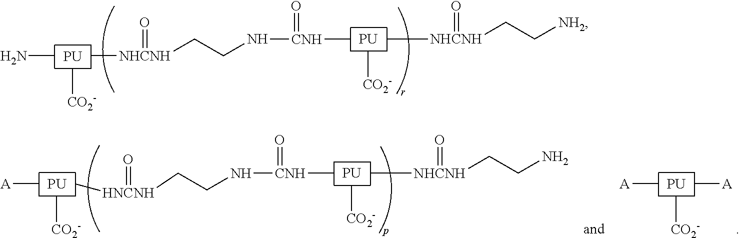

A includes octa-fluoropentanol, hexafluoroisopropanol, trifluoroethanol, tetrafluoropropanol or trifluoroethylamine.

r and p are independently integers ranging between 5˜1000.

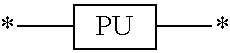

can be expressed as:

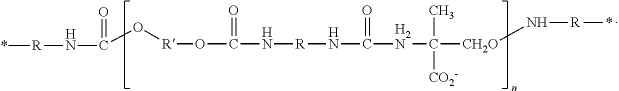

*-R-* may comprise

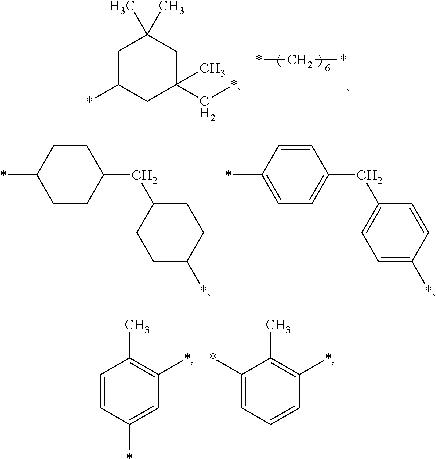

or a combination thereof.

*-R′-* may comprise

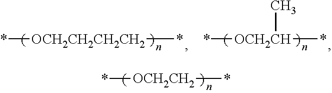

or a combination thereof.

n is an integer ranging between 5˜1000.

The ambient-temperature cross-linking agent may comprise a diversity of poly(ethylene imine) (polyaziridines), polyisocyanate (polyisocyanates) or a combination thereof.

In an embodiment, a solid content of the fluorine containing PU resin may amount to 0.1 wt. %˜45 wt. % of the ambient-temperature self-curable fluorine containing aqueous-based PU dispersion. A weight of the ambient-temperature cross-linking agent may amount to 1%˜10% of the fluorine containing PU resin. The remaining is water.

The application of the ambient-temperature self-curable fluorine containing aqueous-based PU dispersion

The ambient-temperature self-curable fluorine containing aqueous-based PU dispersion of an embodiment of the invention is alkaline (pH>8.0) and not cross-linked stably. After dried by, for example, evaporating water in the atmospheric environment under ambient-temperature, the ambient-temperature self-curable fluorine containing aqueous-based PU dispersion would become acid (pH>7.0) and be self-cross-linked as a modified coated film with a 3D reticular structure. The modified coated film can be expressed as:

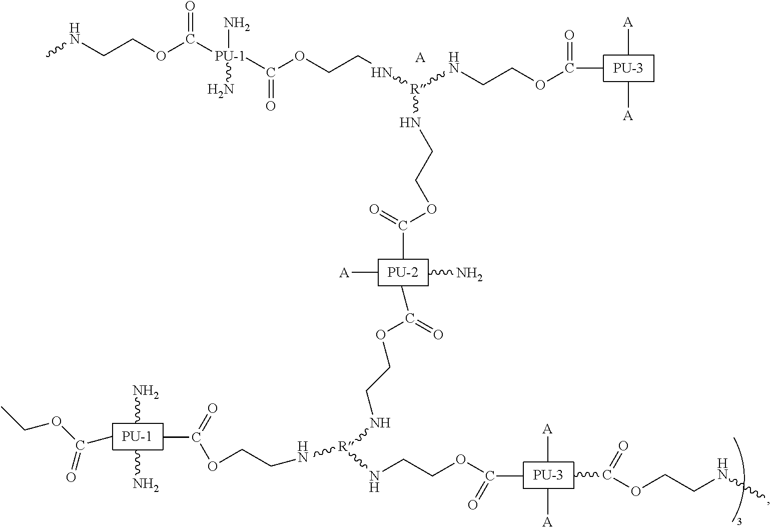

wherein R″ may be alkyl.

The ambient-temperature self-curable fluorine containing aqueous-based PU dispersion of an embodiment of the invention can be applied onto various substrates such as fabric (such as cotton cloth, nylon or polyester (PET) and so on) by way of impregnation, spraying, plate printing or blade coating and so on. The treated substrate is fabric, it becomes water repellent and stain proof. The contact angles of water drops on the fabric is about 125° C.˜135° C. and the contact angles of methylene diiodide (CH2I2) drops on the fabric is about 100° C.˜110° C. (depending on the surface structure on the treated fabric). For example, by drying in the atmospheric environment under ambient-temperature, the ambient-temperature self-curable fluorine containing aqueous-based PU dispersion is self-cross-linked as a soft modified coated film which is water washable and solvent resistant. The ambient-temperature self-curable fluorine containing aqueous-based PU dispersion is easy to use and can thus be used in a do-it-yourself (DIY) manner directly for ordinary users to perform water repellent and stain proof processing on the surface of fabric such as sport jackets, costumes, sport caps, sport shoes. Thus, ordinary users can do DIY water repellent and stain proof processing on personal articles to improve the comfort and convenience. Besides, a self-curable fluorine containing PU resin can be formed by drying the ambient-temperature self-curable fluorine containing aqueous-based PU dispersion coated on the fabric surface under ambient-temperature in which only water is evaporated. During the application process, no toxic volatile organic compound (VOC) is evaporated or discharged. Thus it belongs to an environmental friendly product and its application is a green and cleaner production process.

The method of preparing the ambient-temperature self-curable fluorine containing aqueous-based PU dispersion:

1) Preparation of NCO-Terminated PU Prepolymer:

A first mixture is provided. The first mixture may comprise a melted mixture, an isocyanate and a first catalyst. The molten mixture can be formed by melting the polyol and the dimethylol propionic acid (DMPA). The mole ratio of the polyol to DMPA ranges between 1.5˜4:1, and a water content of the molten mixture is less than 0.02 wt. %. The polyol can be polyoxytetramethylene glycols (PTMEG) whose molecular weight ranges between 250±25˜3000±100, poly(propylene glycol) (PPG) whose molecular weight ranges between 180˜8800, polyethylene glycol whose molecular weight ranges between 180˜8800 or a combination thereof. For example, after the polyol and DMPA are heated and melted, water in the materials can be distilled off under 0.1˜15 torrs to reduce the water content to be <0.02 wt. %. The isocyanate may comprise isophorone diisocyanate (IPDI), hexamethyl diisocyanate (HDI), fully hydrogenated methylene diphenyl diisocyanate (H₁₂MDI), 2,4-toluene diisocyanate (2,4-TDI), 2,6 toluene diisocyanate (2,6-TDI), 1,5-naphthalene diisocyanate (NDI) or a combination thereof. The first catalyst may comprise dibutyl tin octoate (T-12). The mole ratio of isocyanate to polyol may range between 4.0˜6.0:3.0. A weight of the first catalyst may amount to 0.1%±0.02% of a total weight of the polyol, the dimethylol propionic acid (DMPA) and the isocyanate. Then, the first mixture can be heated at 75° C.˜95° C. until a —NCO % reaches to 3.5 wt. %˜5.6 wt. % of the first mixture and becomes a NCO-terminated PU prepolymer.

The present step can be expressed by the following chemical formula:

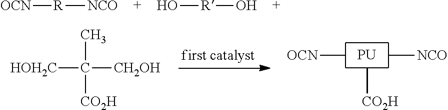

wherein:

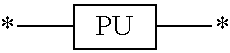

can be expressed as:

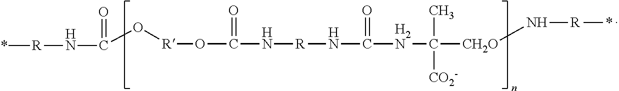

*-R-* may include

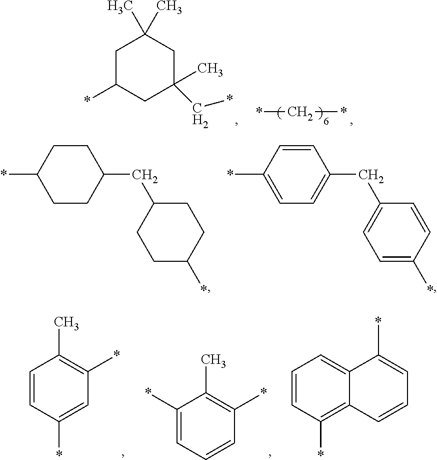

or a combination thereof.

*-R′-* includes

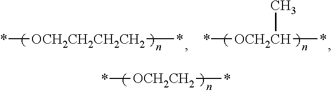

or a combination thereof.

n is an integer ranging between 5˜1000.

2) Preparation of Fluorine Containing PU Hybrid Oligomer:

The fluorine containing compound, a second catalyst and the NCO-terminated PU prepolymer are mixed to obtain a second mixture. The fluorine containing compound is fluorine containing compound having a —OH or —NH₂ functional group that can react with the —NCO functional group. For example, the fluorine containing compound can be realized by octa-fluoropentanol, hexafluoroisopropanol, trifluoroethanol, tetrafluoropropanol, trifluoroethylamine or a combination thereof. A weight of the fluorine of the fluorine containing compound may amount to 0.5%˜25% of the weight of the PU prepolymer. The second catalyst may comprise dibutyl tin octoate (T-12). A weight of the second catalyst is 0.1%±0.02% of a total weight of the PU prepolymer and the fluorine containing compound. Then, the second mixture can be heated at 45° C.˜95° C. until the —NCO of the second mixture amounts to 2.0-3.6 wt. % and its results in a formation of the fluorine containing PU hybrid oligomer.

The present step can be expressed by the following chemical formula:

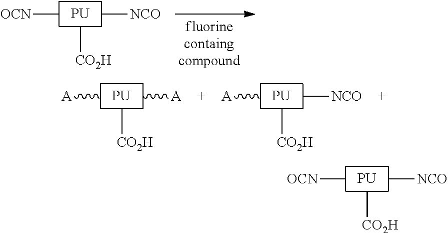

wherein A is a fluorine containing compound.

3) Preparation of Fluorine Containing Aqueous-Based PU Dispersion:

Triethylamine (TEA) is added into the fluorine containing PU hybrid oligomer. pH of the mixture is adjusted to be over 8.0 for example, so that the —COON of the fluorine containing PU hybrid oligomer is neutralized with TEA generating a carboxylic (—COO⁻) ionic group. Then, the neutralized fluorine containing PU hybrid oligomer is mixed with an aqueous solution containing a chain extender to form an aqueous-based PU resin dispersion. The chain extender may comprise ethylenediamine (EDA). The mole ratio of the chain extender to the —NCO of fluorine containing PU hybrid oligomer may range between 0.4˜0.5:1. The weight ratio of the solution containing the chain extender to the fluorine containing PU hybrid oligomer may range between 3˜20:1. Then, water is added into the PU resin dispersion to adjust a solid content of the PU resin dispersion as 0.1 wt. %˜45 wt. % so as to form a fluorine containing aqueous-based PU dispersion.

The present step can be expressed by the following chemical formula:

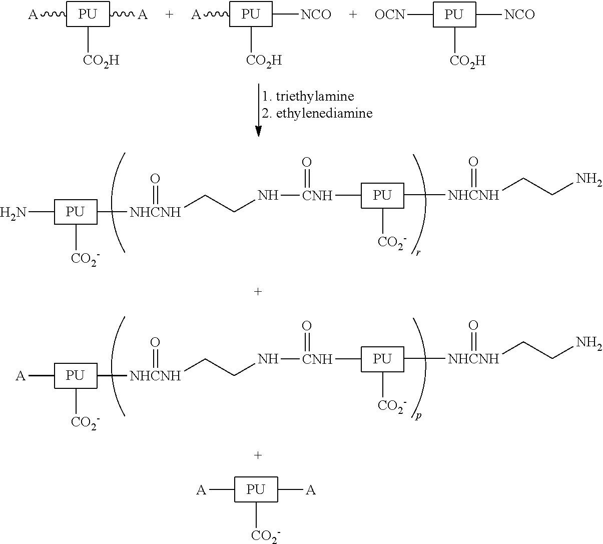

r and p are individually an integer ranging between 5˜1000.

4) Preparation of Ambient-Temperature Self-Curable Fluorine Containing Aqueous-Based PU Dispersion:

The fluorine containing aqueous-based PU dispersion and the ambient-temperature cross-linking agent are mixed to form an ambient-temperature self-curable fluorine containing aqueous-based PU dispersion. The ambient-temperature cross-linking agent may comprise a poly (ethylene imine), polyisocyanate or a combination thereof. A weight of the ambient-temperature cross-linking agent may amount to 0.1 wt.%˜45 wt. % of a solid content of the fluorine containing aqueous-based PU dispersion.

A number of preferred embodiments are disclosed below for detailed descriptions of the objects, features and advantages of the invention:

### Embodiment 1

1) Preparation of NCO Terminated PU Prepolymer:

300.0 g (0.15 mol) of polytetramethylene glycol-2000 (PTMEG-2000) and 13.5 g (0.10 mol) of dimethyl-propionic acid (DMPA) are heated and melted, and then the water content is removed under 0.1˜15 torrs vacuum until the water content is <0.02 wt. %. Next, 120.0 g (0.54 mol) of isophorone diisocyanate (IPDI) are slowly added into a four-necked round bottom reactor, and 0.4 g of reaction catalyst: dibutyl tin octoate (T-12) is added and heated with a mechanical agitator. The reaction mixture is kept at a temperature of 90±5° C. until —NCO %≦5.6 wt. %, and a NCO-terminated PU prepolymer is obtained accordingly.

2) Preparation of Fluorine Containing PU Oligomer:

433.5 g of the PU prepolymer synthesized in step 1) and 40.0 g of octa-fluoropentanol (OFP) are together added into a four-neck reactor and 0.4 g of reaction catalyst: dibutyl tin octoate (T-12) is added. The reaction mixture is kept at a temperature of 90±5° C. until —NCO %≦3.6 wt. %, and a fluorine containing PU oligomer is obtained accordingly.

3) Preparation of Fluorine Containing Aqueous-Based PU Dispersion

Triethylamine (TEA), 12.1 g (0.12 mol) is mixed with the fluorine containing PU hybrid oligomer synthesized in step 2), so that TEA neutralizes the —COON of the fluorine containing PU hybrid oligomer and generating a carboxylic group (—COO⁻). Then, the neutralized fluorine containing PU oligomer is added into an aqueous solution of chain extender, ethylenediamine (EDA) at a rate of 5˜20 mL/min with mechanical agitation at the rates of 500-3000 rpm and it results in a formation of aqueous-based PU resin dispersion. The mole ratio of EDA to —NCO ranges between 0.4→0.5:1. The weight ratio of EDA solution to the fluorine containing PU hybrid oligomer ranges between 3˜20:1. Then, water is added to adjust the solid content 10-30 wt. % to form a final fluorine containing aqueous-based PU dispersion.

4) Preparation of Ambient-Temperature Self-Curable Fluorine Containing Aqueous-Based PU Dispersion:

0.5 g of ambient-temperature cross-linking agent: polyethyleneimine (e.g. CX-100) is added into 100 mL of fluorine containing aqueous-based PU dispersion manufactured in step 3). The reactants are evenly mixed to form an ambient-temperature self-curable fluorine containing aqueous-based PU dispersion.

### Embodiment 2

The method of preparing the ambient-temperature self-curable fluorine containing aqueous-based PU dispersion of the present embodiment is similar to embodiment 1 except that the ambient-temperature cross-linking agent used in step 4) is replaced by 0.8 g of polyisocyanate.

### Embodiment 3

The method of preparing the ambient-temperature self-curable fluorine containing aqueous-based PU dispersion of the present embodiment is similar to embodiment 1 except that the isocyanate: IPDI used in step 1) is replaced by 110.0 g of hexamethyl diisocyanate (hexamethylene diisocyanate; HDI).

### Embodiment 4

The method of preparing the ambient-temperature self-curable fluorine containing aqueous-based PU dispersion of the present embodiment is similar to embodiment 1 except that the isocyanate: IPDI used in step 1) is replaced by 160.0 g fully hydrogenated diphenylmethylene diisocyanate (H¹² diphenylmethylene diisocyanate; H¹² MDI).

### Embodiment 5

The method of preparing the ambient-temperature self-curable fluorine containing aqueous-based PU dispersion of the present embodiment is similar to embodiment 1, wherein the isocyanate: IPDI used in step 1) is replaced by 148.0 g of dual-phenyl diisocyanate (MDI), and the reacting temperature is reduced to 80±5° C. In addition, the reacting temperature of step 2) is adjusted to 80±5° C.

### Embodiment 6

The method of preparing the ambient-temperature self-curable fluorine containing aqueous-based PU dispersion of the present embodiment is similar to embodiment 1 except that the polyol: polyoxytetramethylene (PTMEG-2000) used in step 1) is replaced by 300.0 g of poly(propylene glycol)-2000.

### Embodiment 7

The method of preparing the ambient-temperature self-curable fluorine containing aqueous-based PU dispersion of the present embodiment is similar to embodiment 1, except that the fluorine containing compound: octa-fluoropentanol (OFP) used in step 2) is replaced by 36.0 g of hexafluoroisopropanol (HFIP).

### Embodiment 8

The method of preparing the ambient-temperature self-curable fluorine containing aqueous-based PU dispersion of the present embodiment is similar to embodiment 1 except that the fluorine containing compound: octa-fluoropentanol (OFP) used in step 2) is replaced by 30.0 g of trifluoroethylamine, and the reacting temperature is adjusted to 50±5° C.

In embodiments, after the ambient-temperature self-curable fluorine containing aqueous-based PU dispersion is coated on a fabric fiber such as cotton, Nylon, polyester etc., it reacts by a cross-linking action as the PH of which is <7.0 which resulted from a drying in the atmospheric environment under ambient-temperature. The coated film is a cross-lined film embedded in the fabric fiber. When the ambient-temperature self-curable fluorine containing aqueous-based PU dispersion is coated on the fabric surface by way of impregnation, spraying, plate printing or blade coating, the usage is 2˜15 g/M². The treated fabric is water repellent and stain proof, and the contact angle of water drops on the fabric is about 125°˜135° and methylene diodide (CH₂I₂) drops on the fabric is about 100°˜110° (depends on the textile structure on the fabric surface). Since the fluorine containing compound already forms a chemical bond with the PU resin and becomes a part of the PU resin, after 40 times of washing cycles, the contact angle still remains 90±5% of the original angle. In addition, the fluorine containing PU resin is insoluble in alcohol (dry-clean). Therefore, the treated fabric having characteristics of long-lasting water resistance, solvent resistance, water repellence, and stain proof is obtained.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ambient-temperature self-curable fluorine containing aqueous-based polyurethane (PU) dispersion, comprising:
water;
an ambient-temperature cross-linking agent; and
a fluorine containing PU resin, comprising: 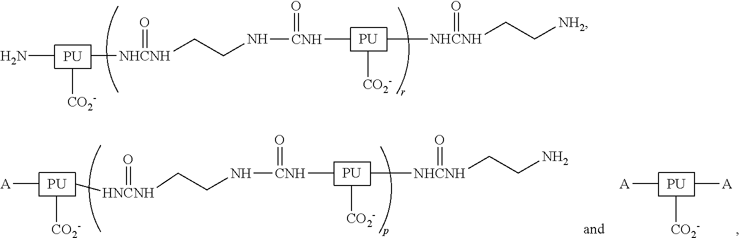
wherein A comprises octa-fluoropentanol, hexafluoroisopropanol, trifluoroethanol, tetrafluoropropanol or trifluoroethylamine.

2. The ambient-temperature self-curable fluorine containing aqueous-based PU dispersion according to claim 1, wherein a solid content of the fluorine containing PU resin amounts to 0.1˜45 wt. %.

3. The ambient-temperature self-curable fluorine containing aqueous-based PU dispersion according to claim 1, wherein a weight of the ambient-temperature cross-linking agent amounts to 1%˜10% of the fluorine containing PU resin.

4. The ambient-temperature self-curable fluorine containing aqueous-based PU dispersion according to claim 1, wherein a solid content of the fluorine containing PU resin amounts to 0.1 wt. %˜45 wt. %, and a weight of the ambient-temperature cross-linking agent amounts to 1%˜10% of the fluorine containing PU resin.

5. The ambient-temperature self-curable fluorine containing aqueous-based PU dispersion according to claim 1, wherein the 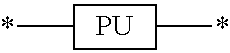
of the fluorine containing PU resin is expressed as: 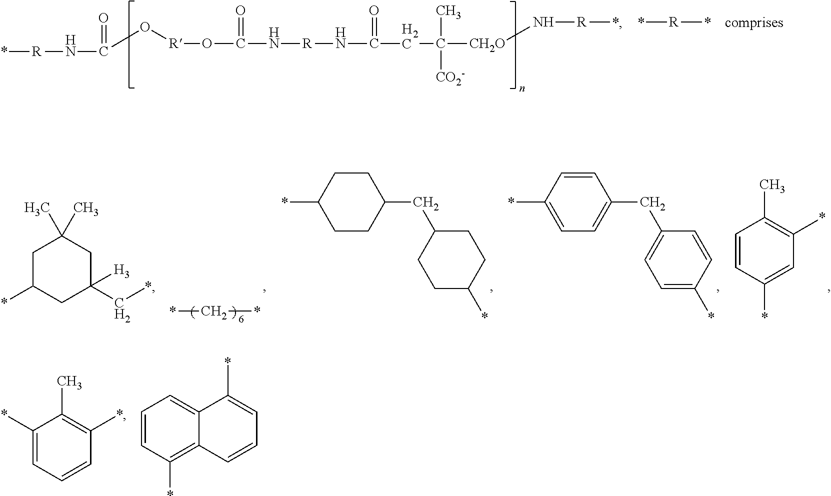
or a combination thereof,
*-R′-* comprises 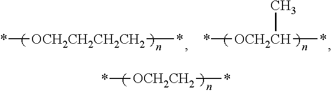
or a combination thereof,
n, r and p independently are integers ranging between 5˜1000.

6. The ambient-temperature self-curable fluorine containing aqueous-based PU dispersion according to claim 1, wherein after the ambient-temperature self-curable fluorine containing aqueous-based PU dispersion is dried in the atmospheric environment, the dispersion will be cross-linked as a 3D networked structure whose chemical formula is expressed as: 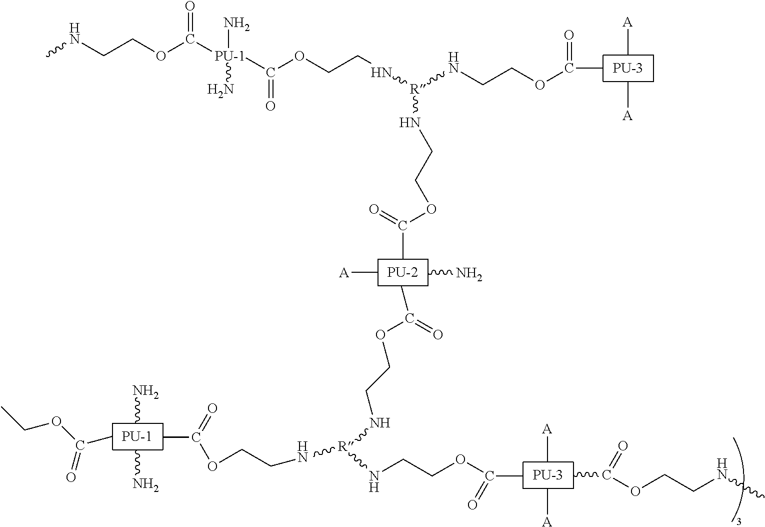
wherein, R″ is alkyl.

7. The ambient-temperature self-curable fluorine containing aqueous-based PU dispersion according to claim 1, wherein after the acid ambient-temperature self-curable fluorine containing aqueous-based PU dispersion is dried and its pH value becomes <7.0, the dispersion is self-cross linked as a 3D networked structure whose chemical formula is expressed as: 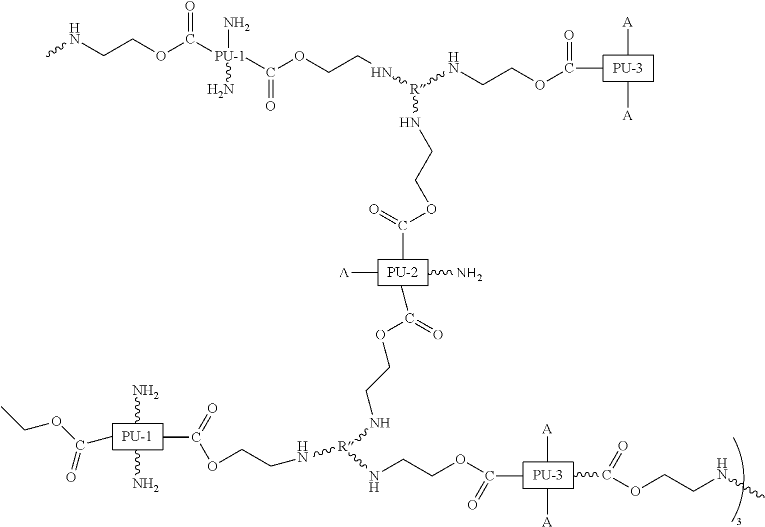
wherein R″ is alkyl.

8. The ambient-temperature self-curable fluorine containing aqueous-based PU dispersion according to claim 1, wherein the ambient-temperature self-curable fluorine containing aqueous-based PU dispersion is prepared by a method comprising:
providing a first mixture, comprising:
a molten mixture formed by melting a polyol and a dimethylol propionic acid (DMPA);
isocyanate; and
a first catalyst comprising dibutyl tin octoate (T-12);
heating the first mixture until a —NCO functional group of the first mixture amounts to 3.5 wt. %˜5.6 wt. % of the first mixture to obtain a PU prepolymer;
mixing a fluorine containing compound, a second catalyst and the PU prepolymer to obtain a second mixture, wherein the second catalyst comprises dibutyl tin octoate (T-12);
heating the second mixture until a —NCO functional group of the second mixture amounts to 2.0˜3.6 wt. % of the second mixture to obtain a fluorine containing PU hybrid oligomer;
adding triethylamine (TEA) to neutralize the fluorine containing PU hybrid oligomer and adjusting pH to be over 8.0;
mixing the neutralized fluorine containing PU hybrid oligomer and a solution containing a chain extender to form an aqueous-based PU resin dispersion, wherein the chain extender comprises ethylenediamine (EDA);
adjusting a solid content of the aqueous-based PU resin dispersion to be 1 wt. %˜35 wt. % by adding water to form a fluorine containing aqueous-based PU dispersion; and
mixing the fluorine containing aqueous-based PU dispersion and the ambient-temperature cross-linking agent to form the ambient-temperature self-curable fluorine containing aqueous-based PU dispersion, wherein a weight of the ambient-temperature cross-linking agent amounts to 1%˜10% of the solid content of the fluorine containing aqueous-based PU dispersion.

9. The ambient-temperature self-curable fluorine containing aqueous-based PU dispersion according to claim 8, wherein:
the melted mixture is formed by melting the polyol and the dimethylol propionic acid (DMPA), wherein the mole ratio of the polyol to the DMPA ranges between 1.5˜4:1 and a water content of the molten mixture is <0.02 wt. %;
the mole ratio of the isocyanate to the polyol ranges between 4.0˜6.0:3.0, and the weight of the first catalyst amounts to 0.1%±0.02% of the total weight of the polyol, the dimethylol propionic acid (DMPA) and the isocyanate;
the heating temperature for the first mixture ranges between 75° C.˜95° C.;
the weight of the fluorine of the fluorine containing compound amounts to 0.5%˜25% of the weight of the PU prepolymer, and the weight of the second catalyst amounts to 0.1%±0.02% of the total weight of the PU prepolymer and the fluorine containing compound;
the heating temperature for the second mixture ranges between 45° C.˜95° C.; and
the mole ratio of the chain extender to a —NCO functional group of the fluorine containing PU hybrid oligomer ranges between 0.4˜0.5:1, and the weight ratio of the solution containing a chain extender to the fluorine containing PU hybrid oligomer ranges between 3˜20:1.

10. The ambient-temperature self-curable fluorine containing aqueous-based PU dispersion according to claim 8, wherein the isocyanate comprises isophorone diisocyanate (IPDI), hexamethyl diisocyanate HDI), fully hydrogenated methylene diphenyl diisocyanate (H₁₂MDI), 2,4-toluene diisocyanate (2,4-TDI), 2,6 toluene diisocyanate (2,6-TDI), 1,5-naphthalene diisocyanate (NDI) or a combination thereof.

11. The ambient-temperature self-curable fluorine containing aqueous-based PU dispersion according to claim 8, wherein the polyol is formed by polymethylene glycols (PTMEG) whose molecular weight ranges between 250±25˜3000±100, poly(propylene glycol) (PPG) whose molecular weight ranges between 180˜8800, polyethylene glycol (PEG) whose molecular weight ranges between 180˜8800 or a combination thereof.

12. The ambient-temperature self-curable fluorine containing aqueous-based PU dispersion according to claim 8, wherein the fluorine containing compound is a —OH or —NH₂ fluorine containing compound which can react with a —NCO functional group.

13. The ambient-temperature self-curable fluorine containing aqueous-based PU dispersion according to claim 8, wherein the fluorine containing compound comprises octa-fluoropentanol, hexafluoroisopropanol, trifluoroethanol, tetrafluoropropanol or trifluoroethylamine.

14. The ambient-temperature self-curable fluorine containing aqueous-based PU dispersion according to claim 1, wherein the ambient-temperature cross-linking agent comprises diversity of poly(ethylene imine), polyisocyanate or a combination thereof.

15. The ambient-temperature self-curable fluorine containing aqueous-based PU dispersion according to claim 1, wherein the method of preparing ambient-temperature self-curable fluorine containing aqueous-based PU dispersion comprises:
providing a first mixture, comprising:
a melted mixture formed by melting the polyol and the dimethylol propionic acid (DMPA), wherein the mole ratio of the polyol to the dimethylol propionic acid (DMPA) ranges between 1.5˜4:1 and the moisture content of the melted mixture <0.02 wt. %;
isocyanate; and
a first catalyst comprising dibutyl tin octoate (T-12), wherein the mole ratio of the isocyanate to the polyol ranges between 4.0-6.0:3.0, and the weight of the first catalyst amounts to 0.1%±0.02% of the total weight of the polyol, the dimethylol propionic acid (DMPA) and the isocyanate;
heating the first mixture at the temperature of 75° C.˜95° C. until a —NCO functional group of the first mixture amounts to 3.5 wt. %˜5.6 wt. % to prepare a NCO-terminated PU prepolymer;
mixing a fluorine containing compound, a second catalyst and the PU prepolymer to obtain a second mixture, wherein the weight of the fluorine of the fluorine containing compound amounts to 0.5%˜25% of the weight of the PU prepolymer, the second catalyst comprises dibutyl tin octoate (T-12), and the weight of the second catalyst amounts to 0.1%±0.02% of the total weight of the PU prepolymer and the fluorine containing compound;
heating the second mixture at the temperature of 45° C.˜95° C. until a —NCO functional group of the second mixture amounts to 2.0 wt. %-3.6 wt. % to prepare a fluorine containing PU hybrid oligomer;
adding triethylamine (TEA) to neutralize the fluorine containing PU hybrid oligomer, and adjusting pH to be over 8.0;
mixing the neutralized fluorine containing PU hybrid oligomer and a solution containing a chain extender to form an aqueous-based PU resin dispersion, wherein the chain extender comprises ethylenediamine (EDA), the mole ratio of the chain extender to a —NCO functional group of the fluorine containing PU hybrid oligomer is 0.4˜0.5:1, the weight ratio of the solution containing a chain extender to the fluorine containing PU hybrid oligomer is 3˜20:1;
adding water into the PU resin dispersion for adjusting a solid content of the PU resin dispersion as 1 wt. %˜35 wt. % to form a fluorine containing aqueous-based PU dispersion; and
mixing the fluorine containing aqueous-based PU dispersion and the ambient-temperature cross-linking agent to form the ambient-temperature self-curable fluorine containing aqueous-based PU dispersion, wherein a weight of the ambient-temperature cross-linking agent amounts to 1%˜10% of the solid content of the fluorine containing aqueous-based PU dispersion.

16. A method of preparing an ambient-temperature self-curable fluorine containing aqueous-based PU dispersion, comprising:
providing a first mixture, comprising:
a melted mixture formed by melting a polyol and a dimethylol propionic acid (DMPA);
an isocyanate; and
a first catalyst comprising dibutyl tin octoate (T-12);
heating the first mixture to preparing a NCO-terminated PU prepolymer;
mixing a fluorine containing compound, a second catalyst and the PU prepolymer to obtain a second mixture, the second catalyst comprises dibutyl tin octoate (T-12);
heating the second mixture to prepare a fluorine containing PU hybrid oligomer;
adding triethylamine (TEA) to neutralize the fluorine containing PU hybrid oligomer, and adjusting pH to be over 8.0;
mixing the neutralized fluorine containing PU hybrid oligomer and a solution containing a chain extender to form an aqueous-based PU resin dispersion, wherein the chain extender comprises ethylenediamine (EDA)
adding water to adjust a solid content of the aqueous-based PU dispersion as 0.1 wt. %˜45 wt. % to form a fluorine containing aqueous-based PU dispersion; and
mixing the fluorine containing aqueous-based PU dispersion and the ambient-temperature cross-linking agent to form the ambient-temperature self-curable fluorine containing aqueous-based PU dispersion, wherein the weight of the ambient-temperature cross-linking agent amounts to 1%˜10% of the solid content of the fluorine containing aqueous-based PU dispersion.

17. A modified coated film, wherein the modified coated film is formed by drying an ambient-temperature self-curable fluorine containing aqueous-based PU dispersion according to claim 1 coated on a substrate.
